(19) United States
(12) Patent Application Publication
(10) Pub. No.: US 2006/0047863 A1
(43) Pub. Date: Mar. 2, 2006

(54) Storage apparatus and data transfer method thereof

(76) Inventor: Minori Awakura, Odawara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/972,420

(22) Filed: Oct. 26, 2004

(30) Foreign Application Priority Data
Aug. 31, 2004 (JP) 2004-251757

(51) Int. Cl. G06F 13/14

(52) U.S. Cl. 710/20

(57) ABSTRACT

A storage apparatus automates a mapping work etc. and can automatically perform online data transfer from a storage unit of a data transfer source between a plurality of storage units. It includes a data transfer means for acquiring the construction information of the second storage in a first storage apparatus before a second storage unit is connected to a communication port for external connection, making a storage device for performing data migrates from the second storage unit to a first storage control unit on the basis of the acquired construction information of the second storage unit, and performing mapping of the storage device in the second storage unit and data transfer from the second storage unit to the first storage control unit, with respect to an external connection function and an online data transfer function, after the second storage unit is connected to the external connection port.

### CROSS-REFERENCE TO RELATED APPLICATION

The present application claims priority from Japanese patent application No. JP 2004-251757 filed on Aug. 31, 2004, the content of which is hereby incorporated by reference into this application.

### BACKGROUND OF THE INVENTION

The present invention relates to a storage apparatus and a data transfer method thereof and, in particular, to a technique effectively applied to online data transfer when a plurality of storage units are connected.

Japanese Patent Laid-Open No. 10-171605 discloses a technique for: performing the online data transfer from an old disk volume of a data-transfer source to a new disk volume of a data-transfer destination between disk volumes in a storage apparatus; and enabling a duplex operation immediately after the data transfer in the storage apparatus and concurrently quick change to the old disk volume when failure in the new disk volume occurs during the data transfer.

### SUMMARY OF THE INVENTION

However, a conventional technique of online data transfer is a technique of the data transfer between the disk volumes in a storage apparatus and therefore has not been considered about the data transfer among a plurality of storage apparatuses connected. Hence, in the conventional technique, the automatic data transfer has not been made among the plurality of storage apparatuses.

Further, when the plurality of storage apparatuses are connected and the data transfer is performed among the plurality of storage apparatuses, it is necessary to execute the following tasks as setting of environment for the data transfer per logic volume (hereinafter abbreviated as “LU”) of a transfer source: confirmation of setting of the environment for the transfer-source LU; mapping of a virtual device (hereinafter abbreviated as “VDEV”) to a logic device (hereinafter abbreviated as “LDEV”) for connecting other storage apparatus at a transfer destination; allotting of the LDEV to the LUN at the transfer destination; and processing of a physical format etc. of the LU at the transfer destination. However, at this time, it is necessary to perform tasks such as manually allotting of the transfer-source LU manually and determining of a transfer-destination PORT.

Therefore, an object of the present invention is to provide a storage apparatus that can automate a mapping task and the like and automatically perform online data transfer from a storage unit at a source of data transfer.

Outlines of representative ones of inventions in disclosed by the present inventors will be briefly described as follows.

A storage apparatus according to the present invention comprises:

a storage control unit; and

a storage unit,

wherein the storage control unit includes:
a plurality of channel adaptors establishing communication with a host unit;
a plurality of disk adaptors establishing communication with the storage unit;
a cache memory temporarily storing data transferred between the host unit and the storage unit;
a shared memory storing control information that communicates with the channel adaptors and the disk adaptors;
a connection unit to which the channel adaptors, the disk adaptors, the cache memory, and the shared memory are connected;
an external connection port to which an external storage unit is connected;
an external connection function recognizing, as an internal storage device, a storage device in the external storage unit connected via the external connection port; and
an online data transfer function performing data transfer between the internal storage devices while processing an access from the host unit,

wherein the storage unit includes a plurality of storage devices, and

wherein the storage apparatus further comprises a data transfer means for: acquiring construction information of the external storage unit before the external storage unit is connected to the external connection port; making a storage device for performing data transfer from the external storage unit, with respect to the storage control unit in accordance with the acquired construction information of the external storage unit; and performing mapping of the storage device in the external storage unit and data transfer from the external storage unit to a side of said storage control unit, with respect to the external connection function and the online data transfer function, after the external storage unit is connected to the external connection port.

Further, a data transfer method of a storage apparatus according to the present invention comprises a storage control unit and a storage unit,

the storage control unit including:
a plurality of channel adaptors establishing communication with a host unit;
a plurality of disk adaptors establishing communication with the storage unit;
a cache memory temporarily storing data transferred between the host unit and the storage unit;
a shared memory storing control information that communicates with the channel adaptors and the disk adaptors;
a connection unit to which the channel adaptors, the disk adaptors, the cache memory, and the shared memory are connected;
an external connection port to which an external storage unit is connected;
an external connection function recognizing, as an internal storage device, a storage device in the external storage unit connected via the external connection port; and
an online data transfer function performing data transfer between the internal storage devices while processing an access from the host unit, and

the storage unit including a plurality of storage devices,

wherein a data transfer process from the external storage unit to a side of the storage control unit comprising the steps of:

acquiring construction information of the external storage unit before the external storage unit is connected to the external connection port;

making a storage device for performing data transfer from the external storage unit with respect to the storage control unit in accordance with the acquired construction information of the external storage unit; and

performing mapping of the storage device in the external storage unit and-data transfer from the external storage unit to a side of said storage control unit, with respect to the external connection function and the online data transfer function, after the external storage unit is connected to the external connection port.

### BRIEF DESCRIPTION OF THE DRAWINGS

FIG. 1 is a block diagram showing a configuration of a storage apparatus according to a first embodiment of the present invention.

FIG. 2 is a schematic diagram for describing external connection in a storage apparatus according to a first embodiment of the invention.

FIG. 3 is a flow chart showing an operation of a data transfer tool of a storage apparatus according to a first embodiment 1 of the invention.

FIG. 4 is a schematic diagram for describing a state where a data transfer tool of a storage apparatus according to a first embodiment of-the present invention is being operated.

FIG. 5 is a schematic diagram for describing a state where a data transfer tool of a storage apparatus according to a first embodiment of the present invention is being operated.

FIG. 6 is a schematic diagram for describing a state where a data transfer tool of a storage apparatus according to a first embodiment of the present invention is being operated.

FIG. 7 is a schematic diagram for describing a state where a data transfer tool of a storage apparatus according to a first embodiment of the present invention is being operated.

FIG. 8 is a schematic diagram for describing a state where a data transfer tool of a storage apparatus according to a first embodiment of the present invention is being operated.

FIG. 9 is a schematic diagram for describing a state where a data transfer tool of a storage apparatus according to a first embodiment of the present invention is being operated.

FIG. 10 is a schematic diagram for describing a state where a data transfer tool of a storage apparatus according to a first embodiment of the present invention is being operated.

FIG. 11 is a schematic diagram for describing a state where a data transfer tool of a storage apparatus according to a first embodiment of the present invention is being operated.

FIG. 12 is a schematic diagram for describing a state where a data transfer tool of a storage apparatus according to a first embodiment of the present invention is being operated.

FIG. 13 is a schematic diagram for describing a state where a data transfer tool of a storage apparatus according to a first embodiment of the present invention is being operated.

FIG. 14 is a schematic diagram for describing a state where a data transfer tool of a storage apparatus according to a first embodiment of the present invention is being operated.

FIG. 15 is a diagram showing an operation of acquiring transfer-source information of a transfer-source storage by a data transfer tool of a storage apparatus according to a first embodiment of the present invention.

FIG. 16 is a diagram showing construction information of a transfer-source storage acquired from a transfer source in a data transfer tool of a storage apparatus according to a first embodiment of the present invention.

FIG. 17 is a diagram showing construction information of a transfer-source storage by external connection in a data transfer tool of a storage apparatus according to a first embodiment of the present invention.

FIG. 18 is a diagram showing construction information of a transfer-source storage merged in a data transfer tool of a storage apparatus according to a first embodiment of the present invention.

FIG. 19 is a flow chart showing an operation of performing an automatic mapping processing of a storage apparatus according to the first embodiment of the present invention.

FIG. 20 is a flow chart showing an operation of performing a manual mapping processing to be a comparative example of a storage apparatus according to the first embodiment of the present invention.

FIG. 21 is a block diagram showing a construction of a storage apparatus according to a second embodiment of the present invention.

FIG. 22 is a schematic diagram for describing a state where a data transfer tool of a storage apparatus according to a second embodiment of the present invention is being operated.

FIG. 23 is a schematic diagram for describing a state where a data transfer tool of a storage apparatus according to a third embodiment of the present invention is being operated

FIG. 24 is a schematic diagram for describing a state where a data transfer tool of a storage apparatus according to a fourth embodiment of the present invention is being operated.

### DESCRIPTION OF THE PREFERRED EMBODIMENTS

Hereinafter, embodiments of the present invention will be detailed based on the drawings. Note that the same members are denoted in principle by the same reference numeral throughout all the drawings for describing the embodiments and the repetitive explanation thereof will be omitted.

### CONCEPT OF THE INVENTION

The present invention performs automatically online data transfer by: using an online data transfer tool (data transfer means) in connecting a storage unit to a storage apparatus through external connection and performing online data transfer from the externally connected storage unit to a storage unit in the storage apparatus; and automatically setting environments of the transfer destination by the data transfer and of the data transfer tool.

As for the setting of the environment, by the use of any one of the following methods, information of the transfer source is extracted and the setting of the environment of the transfer destination and the data transfer are performed.

(1) Perform various tasks required for the data transfer by the use of a data transfer tool on an in-band host;

(2) Perform various tasks required for the data transfer by the use of a data transfer tool on an out-band management console (remote console) or the like;

(3) Perform various tasks required for the data transfer by the use of a data transfer tool (tool operating on an external connection function) on a transfer-destination storage; and

(4) Reflect a file, which is outputted by an output tool for setting environment on a transfer-source storage and includes setting information, with respect to a tool for setting the environment of a transfer-destination storage.

This data transfer tool acquires, first, the environment of a transfer-source storage and the environment of each LU from an inquiry or the like of a SCSI command, makes a table, and determines environment of the transfer destination automatically on the basis of information of the transfer source, and starts setting the environment and performing the data transfer, thereby performing the online data transfer.

### First Embodiment

<Hardware Construction of Storage Apparatus>

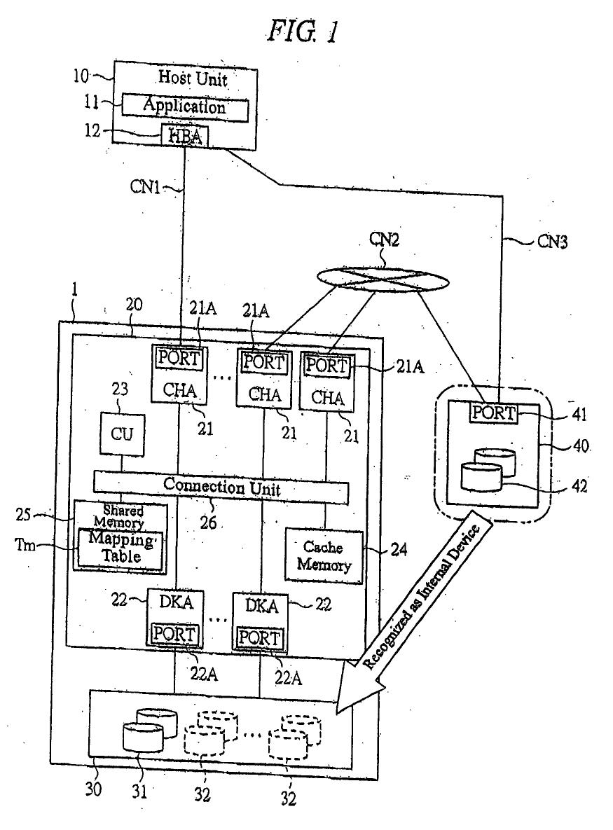

A construction of a storage apparatus according to a first embodiment of the invention will be described with reference to FIG. 1. FIG. 1 is a block diagram showing a constriction of a storage apparatus according to a first embodiment of the present invention and shows an example of In-band by a host unit.

In FIG. 1, a first storage apparatus 1 is constructed from a first storage control unit 20 and a storage unit 30, and the first storage control unit 20 is connected to a host unit 10 through a communication network CN1. The first storage apparatus 1 becomes a data-transfer apparatus of data transfer.

The host unit 10 is a computer unit provided with an information processing source, for example, a CPU (central processing unit) and memory, etc. and is constructed as, for example, a personal computer, work station, main frame, or the like. The host unit 10 is provided with an information input unit (not shown), for example, a keyboard switch, pointing device, microphone, or the like, and an information output unit (not shown), for example, a monitor display, speaker, or the like.

Further, the host unit 10 is provided with application programs 11 such as data base software using a storage region supplied by the first storage control unit 20, a data transfer tool, and the like, and an adaptor 12 for accessing the first storage control unit 20 through the communication network CN1.

A LAN, a SAN, the Internet, a dedicated line, or a public line can be suitably used as the communication network CN1 as occasion demands. Data communication through the LAN is performed, for example, according to TCP/IP (Transmission Control Protocol/Internet Protocol). In the case where the host unit 10 is connected to the first storage control unit 20 through the LAN, the host unit 10 specifies a file name and requests a data input/output per file.

On the other hand, in the case where the host unit 10 is connected to the first storage device 20 and the like through a SAN, the host unit 10 requests a data input/output per block that is a data management unit of a storage region provided by a plurality of disk storage units (disk drives) according to a fiber channel protocol. In the case where the communication network CN1 is a LAN, the adaptor 12 is, for example, a LAN-capable network card. In the case where the communication network CN1 is a SAN, the adaptor 12 is, for example, a host bus adaptor.

Further, the host unit 10 is connected to a second storage unit 40 through a communication network CN3. The communication network CN3 can be constructed from, for example, a SAN, a LAN, the Internet, a dedicated line, or public line. The second storage unit 40 becomes a transfer-source storage unit of data transfer.

Note that, in the drawing, the host unit 10 is connected to the second storage unit 40 through the communication network CN3, but the host unit 10 may be connected to the second storage unit 40 through the communication network CN2. Further, the host unit 10 is selectively connected to the first storage apparatus 1 or the second storage unit 40 by the adaptor 12, or can be connected at the same time to the first storage apparatus 1 and the second storage unit 40 by a plurality of adaptors 12.

The first storage control unit 20 is constructed as, for example, a disk array sub-system. However, the first storage control unit 20 is not limited to the disk array sub-system and can be also constructed as a high-functionality intelligent fiber channel switch.

The first storage control unit 20 is provided with, for example, a plurality of channel adaptors (CHA) 21, a plurality of disk adaptors (DKA) 22, a control unit (CU) 23, a cache memory 24, a shared memory 25, and a connection unit 26.

Each channel adaptor 21 conducts data communication with the host unit 10. Each channel adaptor 21 is provided with a communication port 21A for establishing communication with the host unit 10.

Further, each channel adaptor 21 is constructed as a microcomputer system provided with a CPU, a memory, and the like and interprets and executes various kinds of commands received from the host unit 10. A network address (for example, IP address or WWN) for identifying each adaptor 21 is allotted to each channel adaptor 21, and each channel adaptor 21 can behave individually as a NAS (Network Attached Storage). In the case where a plurality of host units 10 exist, each channel adaptor 21 can receive a request individually from each host unit 10.

Each of the disk adaptors 22 gives and receives data between storage devices 31 and 32 of the storage unit 30. Each disk adaptor 22 is provided with a communication port 22A for being connected to the storage devices 31 and 32. Further, each disk adaptor 22 is constructed as a microcomputer system provided with a CPU, a memory, and the like. Each disk adaptor 22 writes data, which the channel adaptor 21 receives from the host unit 10, to a predetermined address of the predetermined storage devices 31, 32 on the basis of a request (write command) from the host unit 10 and reads data from a predetermined address of the predetermined storage devices 31, 32 on the basis of a request (read command) from the host unit 10 and sends the data to the host unit 10. When data is inputted or outputted between the storage devices 31, 32, each disk adaptor 22 converts a logic address to a physical address. Each disk adaptor 22 performs a data access according to a RAID construction when the storage devices 31, 32 are managed based on a RAID.

The control unit 23 is one that controls operations of the whole apparatus. To the control unit 23 is connected, for example, a storage management console (SVP/Web console) for management (not shown). The control unit 23 is adapted to monitor occurrence of failure in the apparatus and to display it on the storage management console and is instructed on a closing process etc. for a storage disk on the basis of a command from the storage management console.

The cache memory 24 temporarily stores data received from the host unit 10 and data read from the storage devices 31, 32. In the shared memory 25 are stored control information and the like. Further, in the shared memory 25 is set a work region and is stored also various kinds of tables such as a mapping table Tm which will be described later. Note that one or a plurality of storage devices 31, 32 may be used as one or a plurality of disks for cache memory.

The connection unit 26 connects the respective channel adaptors 21, the respective disk adaptors 22, the control unit 23, the cache memory 24, and the shared memory 25 to one another. The connection unit 26 can be constructed as a high-speed bus, for example, an ultrahigh-speed crossbar switch that transmits data by a high-speed switching operation and the like.

The storage unit 30 includes a plurality of storage devices 31. As the storage device 31 can be used a device such as a hard disk, flexible disk, magnetic tape, semiconductor memory, or optical disk. The storage devices 32 shown by dotted lines in the storage unit 30 shows a state where a storage device 42 included by the second storage unit 40 is taken into a side of the first storage apparatus 1. That is, in this embodiment, the storage device 42 existing outside the first storage apparatus 1 is recognized as an internal storage device of the first storage apparatus 1 and a storage resource of an external storage device 42 is provided to the host unit 10.

The second storage unit 40 includes a communication port 41 and the storage device 42. In addition, as is the case with the first storage apparatus 1, the second storage unit 40 can also include a channel adaptor and a disk adaptor. The second storage unit 40 may be constructed in any manner if the second storage unit 40 is externally connected to the first storage apparatus 1 and the first storage apparatus 1 can recognize the second storage unit 40 as an internal storage device.

The second storage unit 40 is connected to the first storage control unit 20 through the communication network CN2 and the storage device 42 in the second storage unit 40 is handled as an internal storage device in the first storage control unit 20.

In this embodiment, the second storage unit 40 is first connected to the host unit 10 and utilized and when data transfer from the second storage unit 40 to the first storage apparatus 1 is conducted, the second storage unit 40 is externally connected to the first storage apparatus 1 and is recognized as the internal storage device of the first storage control unit 20, whereby the data transfer is conducted in online.

<External Connection>

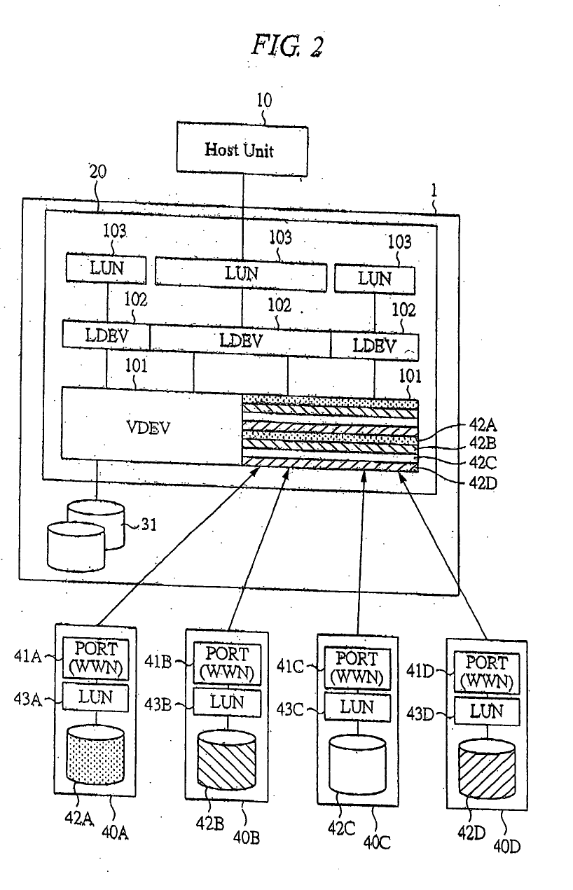

Next, external connection in a storage apparatus according to the first embodiment of the present invention will be described with reference to FIG. 2. FIG. 2 is a schematic diagram for describing external connection in the storage apparatus according to the first embodiment of the invention and schematically shows one logic structure of the first storage control unit 20 and the storage device 32.

In FIG. 2, the first storage control unit 20 has a three-level storage hierarchy of a VDEV 101, a LDEV 102, and a LUN 103 in this order from a lower side.

The VDEV 101 is a virtual device located at the lowest level of the logic storage hierarchy. The VDEV 101 is one obtained by making a physical storage resource virtual and a RAID construction can be applied to the VDEV 101. That is, a plurality of VDEVs 101 can be formed from one storage device 31 (slicing) and one VDEV 101 can be formed from a plurality of storage devices 31 (striping). In the VDEV 101 shown on the left side in FIG. 2, for example, the storage device 31 is made virtual according to a predetermined RAID construction.

On the other hand, the VDEV 101 shown on the right side in FIG. 2 is constructed by mapping the storage device 42 of the second storage apparatus 40. That is, in this embodiment, a logic volume (LDEV) provided by the storage device 42 of the second storage apparatus 40 is mapped to the VDEV 101 by the use of a mapping table Tm that will be described later, so that the storage device 42 can be used as an internal volume of the first storage control unit 20.

In the example shown in the drawing, the VDEV 101 is constructed by striping four storage devices 42A to 42D. The respective storage devices 42A to 42D can be accessed individually by specifying the LUNs 43A to 43D from the respective communication ports 41A to 41D. Since WWNs that are unique identification information are allotted to the respective communication ports 41A to 41D and LUN numbers are set for the respective LUNs 43A to 43D, the storage device can be identified by combination of the WWN and the LUN number.

The LDEV 102 is provided on the VDEV 101. The LDEV 102 is a virtual logic device (logic volume) obtained by making the virtual device (VDEV) virtual. Two LDEVs 102 can be connected to one VDEV 101 and a plurality of VDEVs 101 can be connected to one LDEV 102. The LDEV 102 can be accessed via the respective LUNs 103.

Thus, in this embodiment, the storage device 42 is connected to intermediate storage hierarchic layers (VDEV 101, LDEV 102) located between the LUN 103 and the storage device 42, whereby the external storage device 42 can be used as one internal volume of the first storage control unit 20. That is, an internal section and an external section of the storage apparatus 1 can be equivalently handled.

Further, when the second storage unit 40 is externally connected, it is necessary to allot the LUN and the LDEV so that the host unit 10 can surely refer to the externally connected second storage unit 40. Further, not only the setting of the LUN and the LDEV is required, but also the formatting of the LU of the transfer destination in necessary size in accordance with the size of the LU of the transfer source is required when the data transfer is conducted. In this embodiment, the information of the second storage unit 40 of the transfer source is acquired as preparation before external connection by the data transfer tool, and the construction of the first storage apparatus 1 of the transfer destination at the time of the external connection is set, whereby the LUN and the LDEV, etc. can be automatically allotted.

In conducting data migration etc., the setting of a large amount of LUNs and LDEVs is required. However, by allotting the LUNs and LDEVs automatically, steps of the data migration can be reduced and tasks thereof can be conducted with accuracy.

<Operation of Data Transfer Tool>

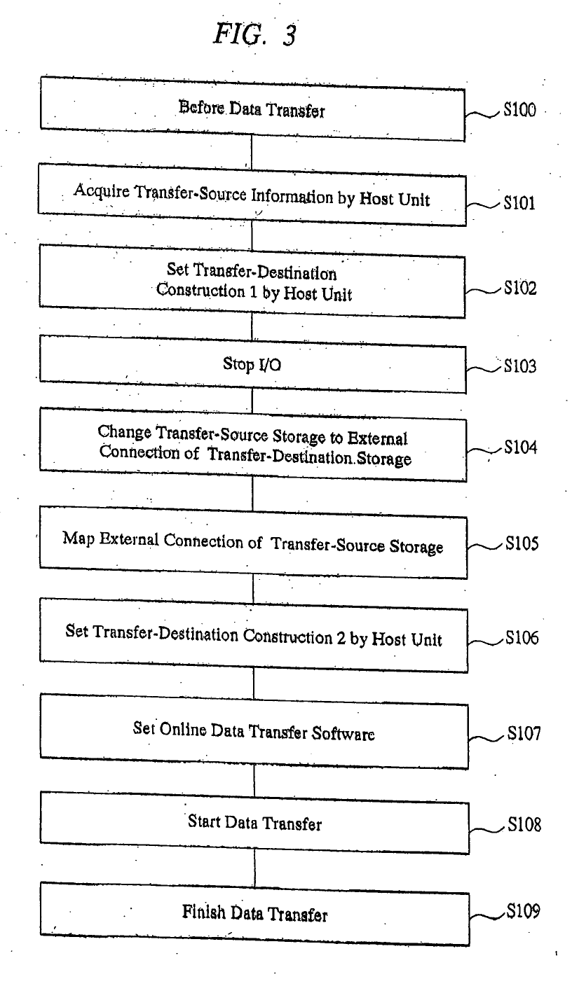

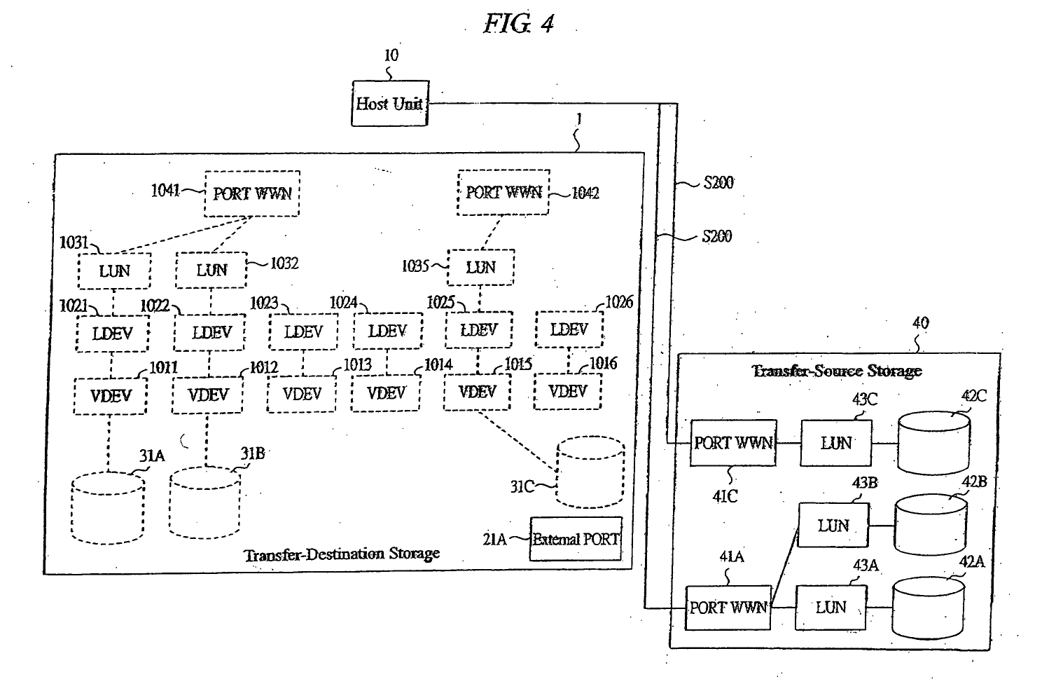

Next, an operation of the data transfer tool of the storage apparatus according to the first embodiment of the invention will be described with reference to FIGS. 3 to 18. FIG. 3 is a flow chart showing the operation of the data transfer tool of the storage apparatus according to the first embodiment 1 of the invention. FIGS. 4 to 14 are schematic diagrams for describing a state where the data transfer tool of the storage apparatus according to the first embodiment of the present invention is being operated, and show one logic schematic structure of the first storage apparatus 1 and the second storage unit 40.

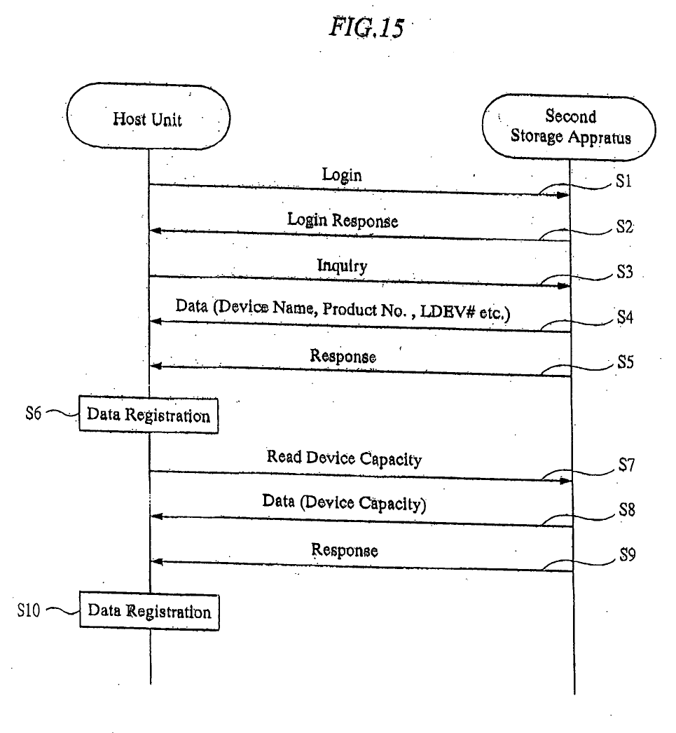

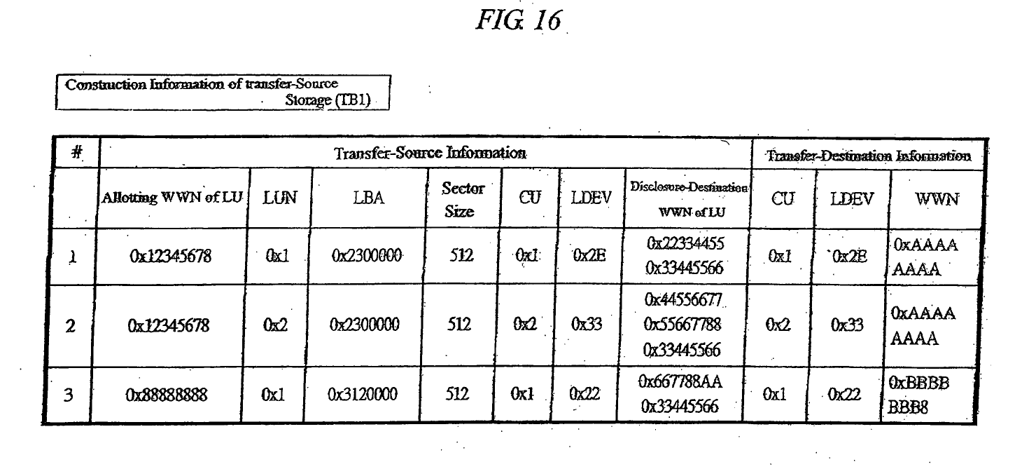

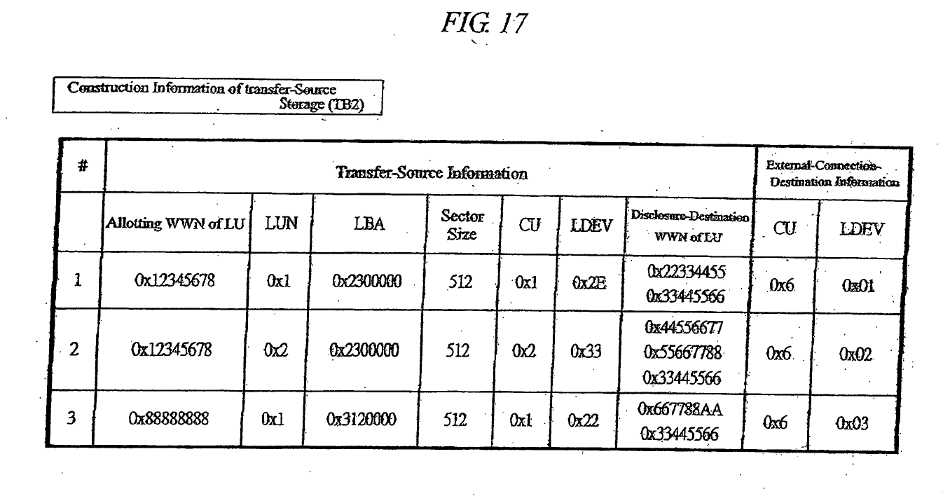

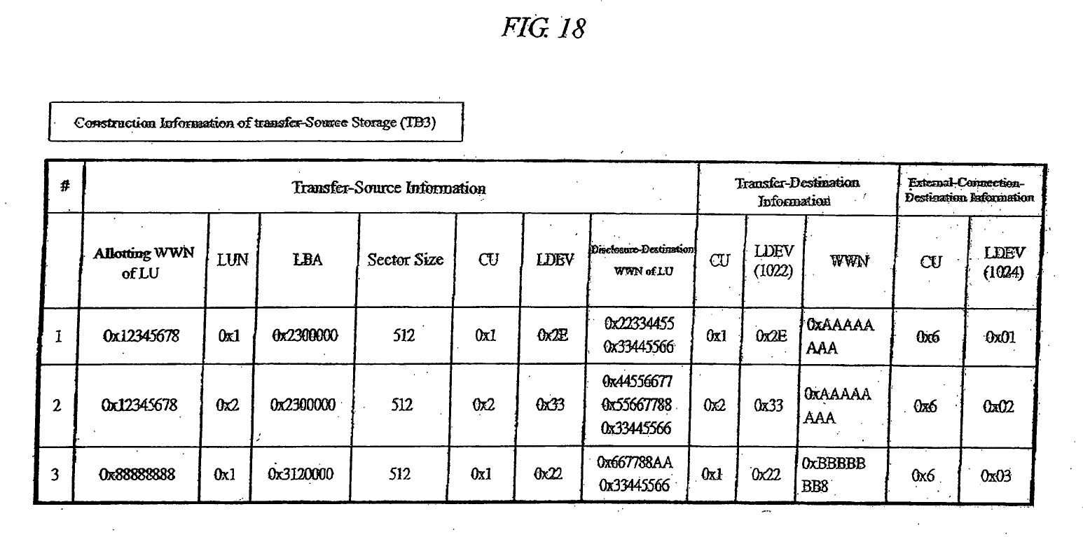

FIG. 15 is a diagram showing an operation of acquiring transfer-source information of a transfer-source storage by the data transfer tool of the storage apparatus according to the first embodiment of the present invention. FIG. 16 is a diagram showing construction information of a transfer-source storage acquired from the transfer source in the data transfer tool of the storage apparatus according to the first embodiment of the present invention. FIG. 17 is a diagram showing construction information of a transfer-source storage by the external connection in the data transfer tool of the storage apparatus according to the first embodiment of the present invention. FIG. 18 is a diagram showing construction information of the transfer-source storage merged in the data transfer tool of the storage apparatus according to the first embodiment of the present invention.

In FIGS. 4 to 14, the transfer-source storage (second storage unit) 40 has storage devices 42A to 42C to be sources of the transfer and is set in such a way that the storage devices 42A to 42c can be identified by means of the LUNs 43A to 43C and the WWNs of the communication ports 41A to 41C. Further, the transfer-destination storage (first storage apparatus) 1 has: a region where storage devices 31A to 31C used for the data transfer from the storage devices 42A to 42C of the transfer-source storage 40 can be produced; and a communication port 21A for external connection, and can utilize the internal storage device and the externally connected storage device as internal volumes for the host unit 10 by means of VDEVs 1011 to 1016, LDEVs 1021 to 1026, LUNs 1031 to 1035, and communication port WWNs 1041 and 1042.

First, as shown in FIG. 3, the host unit 10 accesses the transfer-source storage 40 as a data transfer-before state (S100).

In the state of S100 shown in FIG. 3, as shown in FIG. 4, the host unit 10 is connected to the transfer-source storage 40 and the host unit 10 makes a usual read/write access to the transfer-source storage 40 (S200). In this state, nothing is set in the transfer-destination storage 1.

Then, the host unit 10 acquires the transfer-source information in the online and creates construction information of transfer-source storage (TB1), as shown in FIG. 16 (S101).

The construction information of transfer-source storage (TB1), as shown in FIG. 16, is constructed from numbers, information of a transfer source, and information of a transfer destination, which are automatically allotted to items of a table. The information of the transfer source includes: information of “allotting WWN of LU” that is a number for identifying 41A and 41C in FIG. 4; “LUN” that is a number for identifying 43A, 43B, and 43C in FIG. 4; “LBA” and “sector size” that are units showing the size of a disk; “CU” that shows the position of a disk in combination with LDEV; “LDEV” that shows the position of a disk in combination with CU; and “disclosure-destination WWN of LU”, which is WWN of HBA that is a disclosure destination of the disk. The information of the transfer destination includes information of: “CU” that is a copy of the CU of the transfer source; “LDEV” that is a copy of the LDEV of the transfer source; and “WWN” for identifying the port of the transfer destination. Note that, the “WWN” of the information of the transfer destination is not the information acquired at S101 in FIG. 3 but the information set by the information of “allotting WWN of LU” that is the information of the transfer source and the information of the construction in the transfer-destination storage 1.

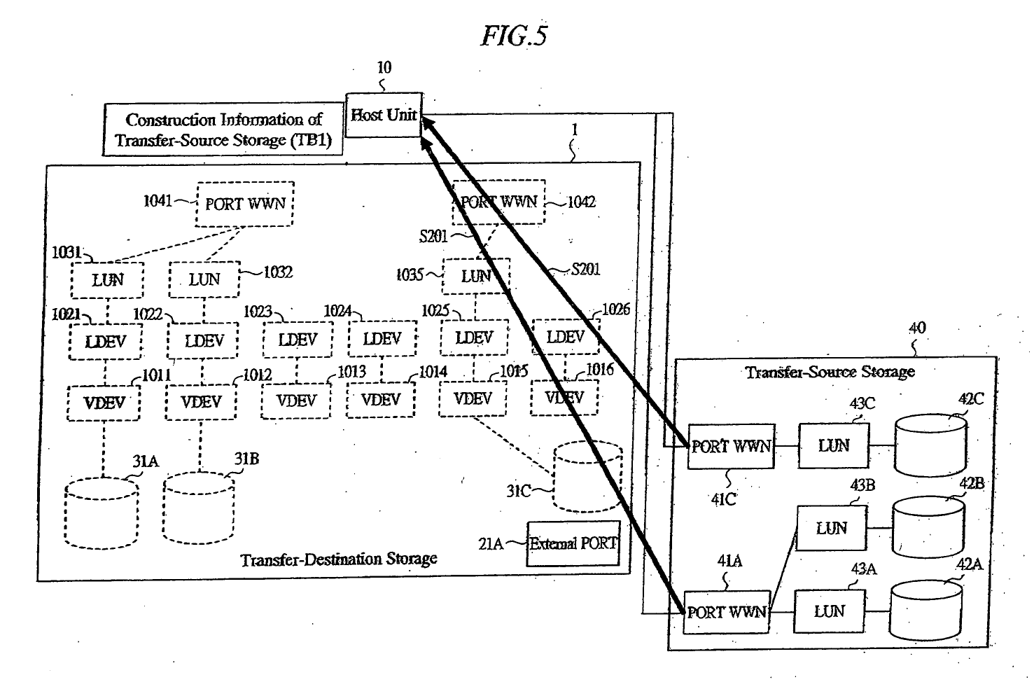

In the state of S101 shown in FIG. 3, as shown in FIG. 5, the host unit 10 is connected to the source-transfer storage 40 and the information of the transfer source is online-transmitted from the source-transfer storage 40 to the host unit 10 (S201) and the construction information of source-transfer storage (TB1) is made on a side of the host unit 10.

Here, one example of acquiring the transfer-source information from the transfer-source storage 40 at S101 will be described with reference to FIG. 15.

First, the host unit 10 logs in the second storage apparatus 40 via the adaptor 12 (S1). The second storage apparatus 40 responds to the login of the host unit 10, whereby the login is finished (S2). Next, the host unit 10 transmits an inquiry command defined by, for example, a SCSI (small computer system interface) standard to the second storage apparatus 40 and requests the detail of the storage device 42 included in the second storage apparatus 40 (S3).

The inquiry command is used to clarify the kind and construction of inquiry-destination device, and can acquire a physical structure of the inquiry-destination device through a hierarchy the inquiry-destination device has. By using the inquiry command, the host unit 10 can acquire information of, for example, a device name, a device type, a product number (product ID), a LDEV number, various versions, and a bender ID, etc. from the second storage apparatus 40 (S4). The second storage apparatus 40 transmits the inquired information to the host unit 10 to respond to the inquiry command (S5).

The host unit 10 registers the information acquired from the second storage apparatus 40, into the construction information of transfer-source storage (TB1) shown in FIG. 16 (S6). Next, the host unit 10 reads the storage capacity of the storage device 42 from the second storage apparatus 40 (S7). The second storage apparatus 40 sends the storage capacity of the storage device 42 in response to the inquiry from the host unit 10 (S8) and returns a response (S9). The host unit 10 registers the storage capacity of the storage device 42 into the predetermined position of the construction information of transfer-source storage (TB1) (S10). By performing the processing described above, the construction information of transfer-source storage (TB1) can be constructed.

Then, the information of the transfer source is acquired at S101 and thereafter the host unit 10 is connected to the transfer-destination storage 1 and sets the transfer-destination construction, for example, a LU format provided with the same capacity, the same CU, and the same LDEV number as those of a transfer source that becomes the transfer destination during the online, on the basis of the construction information of transfer-source storage (TB1) (S102), and stops an input/output to/from the transfer-source storage 40 (S103).

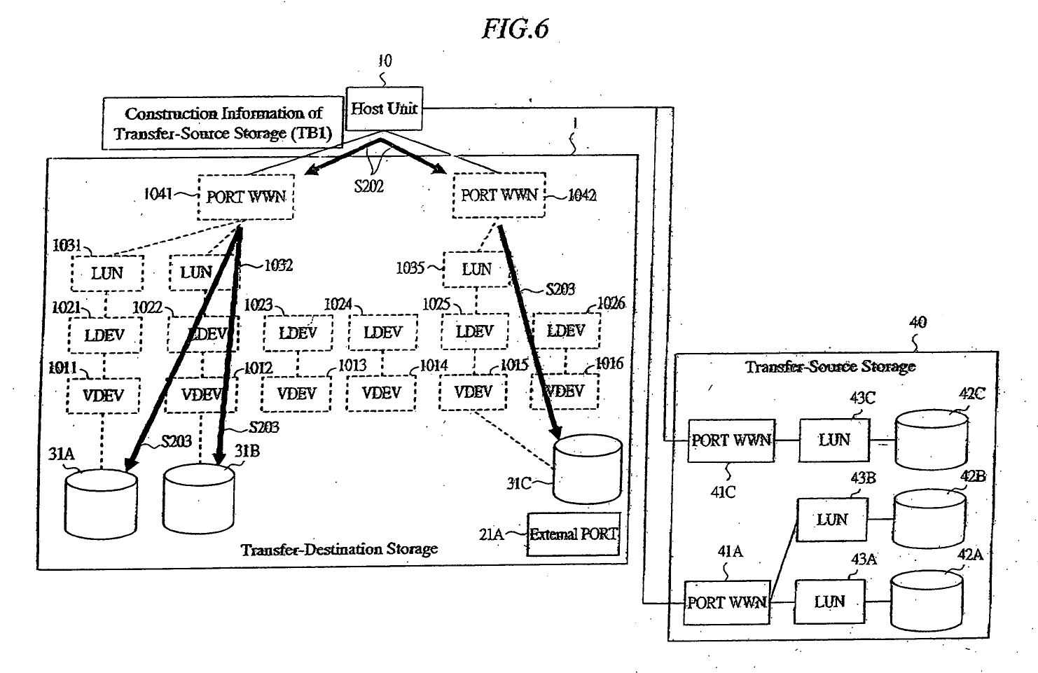

In the state of S102 shown in FIG. 3, as shown in FIG. 6, the host unit 10 can determine the capacity of the LU of the transfer destination on the basis of the construction information of transfer-source storage (TB1) and formats the LU, which has the same capacity, the same CU, and the same LDEV number as those of the transfer source, via the port 1041 and the port 1042 (S202), and makes a LU for data transfer from the transfer-source storage 40 (S203).

Note that, at S102 in FIG. 3, the LU having the same capacity, the same CU, and the same LDEV number as those of the transfer source is formatted as the setting of the construction of the transfer destination. However, the capacity of the transfer destination can be larger than that of the transfer source.

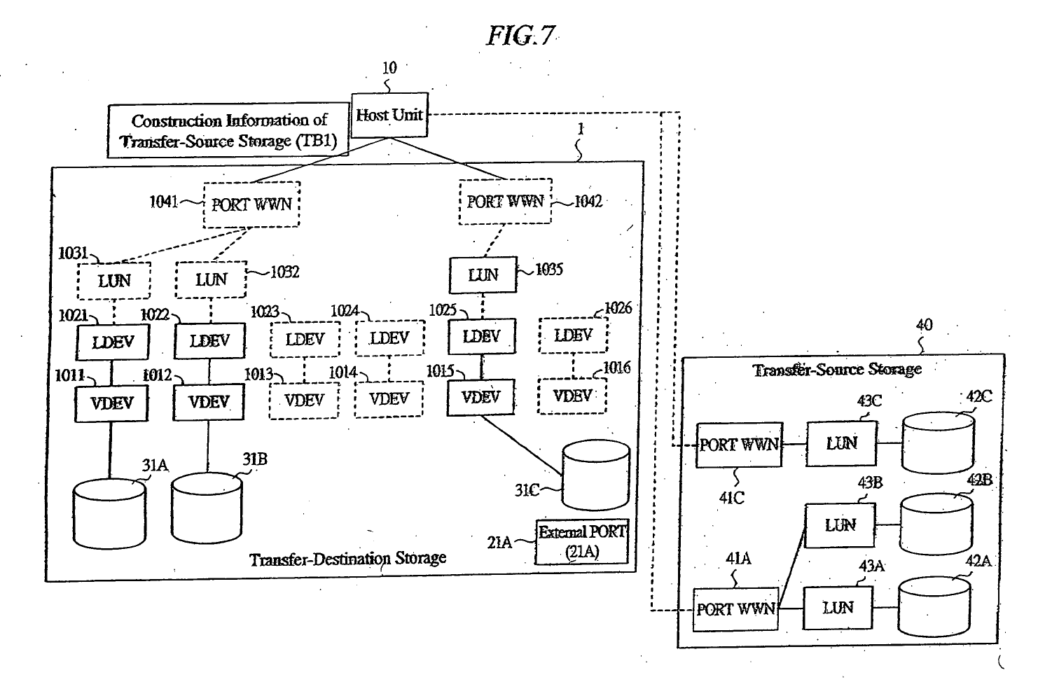

Then, in the state of S103 shown in FIG. 3, as shown in FIG. 7, an input/output of the transfer-source storage 40 connected to the host unit 10 is stopped and a connection between the host unit 10 and the transfer-source storage 40 is disconnected.

Note that, at S102 in FIG. 3, in connecting the host unit 10 to the transfer-destination storage 1, if the connection of the host unit 10 to the transfer-source storage 40 is changed, the input/output of the host unit 10 to the transfer-source storage 40 is stopped and then the host unit 10 is connected to the transfer-destination storage 1.

Then, the transfer-source storage 40 is connected to the communication port 21A for external connection and the transfer-source storage 40 is switched to the external connection of the transfer-destination storage 1 and the information of the transfer-source storage 40 connected externally by discovery of the communication port 21A for the external connection is acquired and the construction information of transfer-source storage (TB2) shown in FIG. 17 is made (S104).

The construction information of transfer-source storage (TB2) shown in FIG. 17 is constructed from numbers, information of a transfer source, and information of an external-connection destination, which are automatically allotted to the items of the table. The information of the transfer source includes various pieces of information of “allotting WWN of LU”, “LUN”, LBA/, “sector size”, “CU”, “LDEV”, and “disclosure-destination WWN of LU”, and the information of the external-connection destination includes the information of “CU” and “LDEV”.

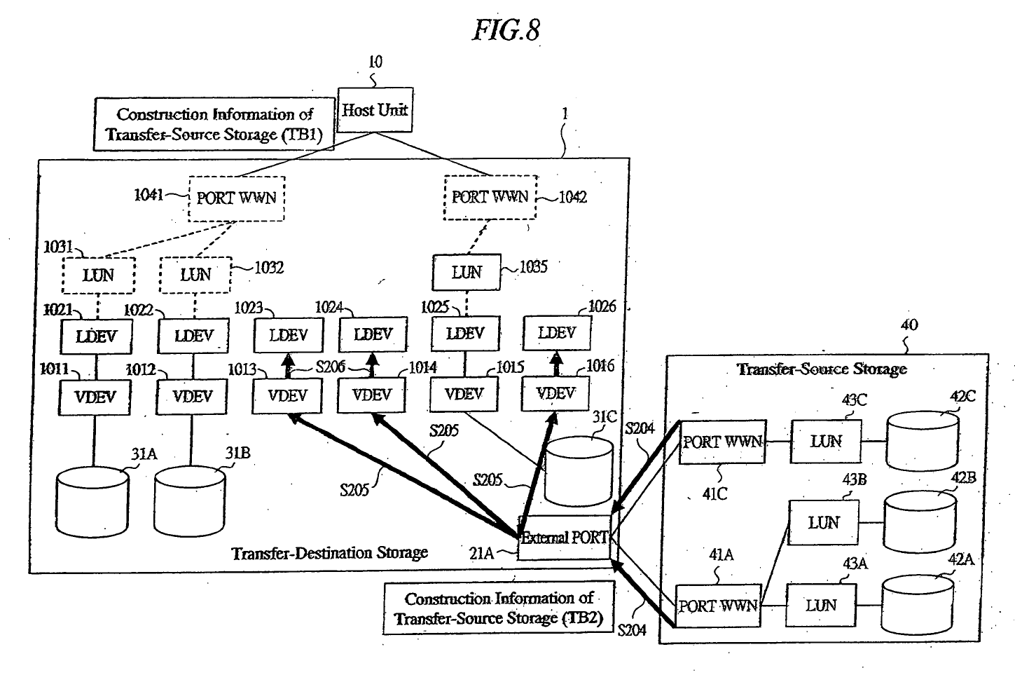

In the state of S104 shown in FIG. 3, as shown in FIG. 8, the transfer-source storage 40 is connected to the communication port 21A for external connection of the transfer destination, and the information of the externally connected transfer-source storage 40 is acquired on a side of the communication port 21A for external connection (S204), and the construction information of transfer-source storage (TB2) shown in FIG. 17 is made. Further, in the allotting of VDEVs to the externally connected transfer-source storage 40, unused VDEVs are automatically allotted (S205) and the information is also automatically allotted to the LDEVs (S206).

Under the condition, if the LDEV allotted to the transfer-source storage 40 is mapped to the LUN, it becomes possible to access the transfer-source storage 40 from the host unit 10.

Then, the construction information of transfer-source storage (TB1) acquired at S102 in FIG. 3 is checked against that of transfer-source storage (TB2) acquired at S104 in FIG. 3 to update the construction information of transfer-source storage (TB1) and make the construction information of transfer-source storage (TB3) shown in FIG. 18 (S105).

The construction information of transfer-source storage (TB3) shown in FIG. 18 is constructed from numbers, information of a transfer source, information of a transfer-destination, and information of a external-connection destination, which are automatically allotted to the items of the table. The information of the transfer source includes various pieces of information of “allotting WWN of LU”, “LUN”, “LBA”, “sector size”, “CU”, “LDEV”, and “disclosure-destination WWN of LU”, and the information of the transfer destination includes various pieces of information of “CU”, “LDEV”, and “WWN”, and the information of the external-connection destination includes various pieces of information of “CU” and “LDEV”.

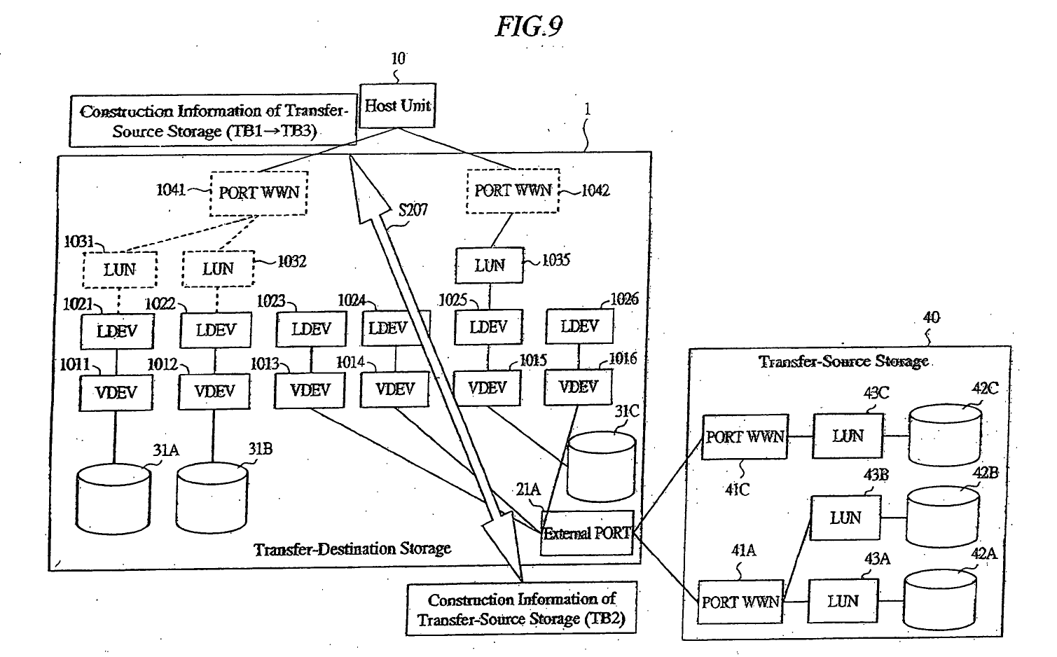

In the state of S105 shown in FIG. 3, as shown in FIG. 9, the transfer-source storage 40 is externally connected to the transfer-destination storage 1, and the construction information of transfer-source storage (TB1) made on a side of the host unit 10 and the construction information of transfer-source storage (TB2) made on a side of the communication port 21A for the external connection are referred to each other (S207), whereby construction information of transfer-source storage (TB3), in which is merged by the construction information of transfer-source storage (TB1) and that of transfer-source storage (TB2), is created.

Further, a command device is used to take out the construction information of transfer-source storage (TB2) from the host unit 10.

Further, as for a method for making the construction information of transfer-source storage (TB3), a combination of the same WWN and the same LU is found from the information of “allotting WWN of LU” and the information of “LUN”, for example, in the construction information of transfer-source storage (TB1) shown in FIG. 16 and that of transfer-source storage (TB2) shown in FIG. 17, and the construction information of transfer-source storage (TB1) is merged with the construction information of external-connection destination in that of transfer-source storage (TB2) to make one table, whereby the construction information of transfer-source storage (TB3) is made.

By this construction information of transfer-source storage (TB3), information can be acquired in which the transfer-destination information with regard to the transfer-source information corresponds to the information of external-connection destination.

Then, the construction of the transfer-destination storage 1 related to the externally connected transfer-source storage 40 is set on the basis of the construction information of transfer-source storage (TB3) made at S105 in FIG. 3 to map the LDEVs on the LUNs (S106). By this processing, the externally connected transfer-source storage 40 is mapped in such a state as to be accessed from the host unit 10, and the I/O to the externally connected transfer-source storage 40 from the host unit 10 is resumed.

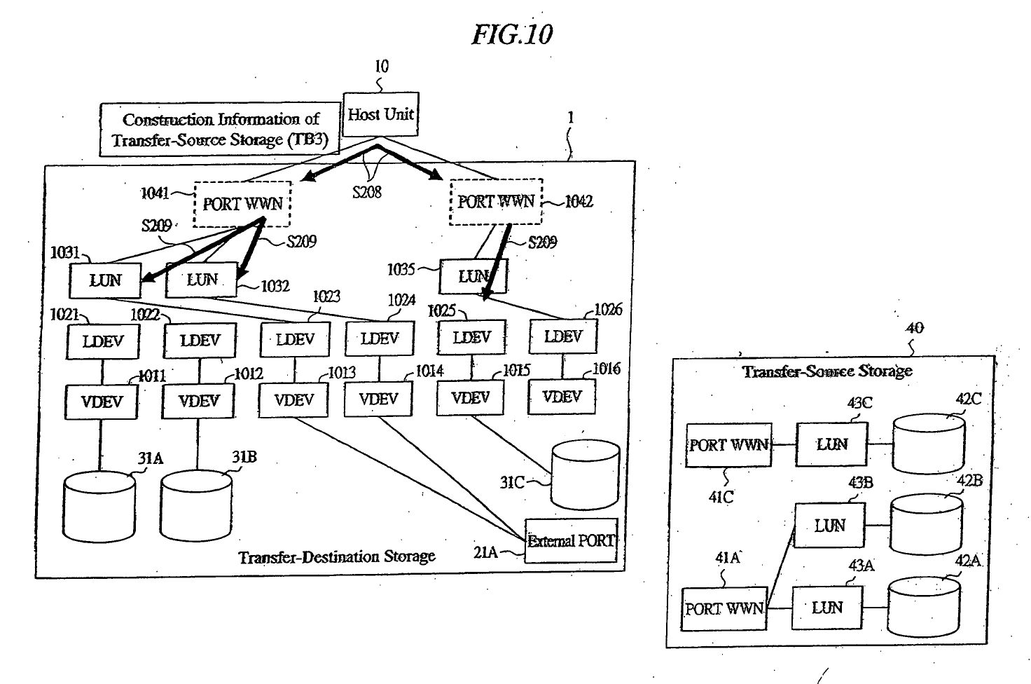

In the state of S106 shown in FIG. 3, as shown in FIG. 10, the LUNs are mapped to the LDEVs allotted to the externally connected transfer-source storage 40 via the ports 1041 and 1042 (S208) on the basis of the construction information of transfer-source storage (TB3) made on the side of the host unit 10 (S209). By this mapping, the access to the externally connected transfer-source storage 40 from the host unit 10 becomes possible and the I/O to the externally connected transfer-source storage 40 from the host unit 10 is resumed, whereby the side of the host unit 10 becomes in such a state as to access the externally connected transfer-source storage 40 similarly to the case where the host unit 10 is directly connected to the transfer-source storage 40.

Then, connection of an online data transfer software by which a data transfer processing during the online is performed as closed control is set in the transfer-destination storage 1 on the basis of the construction information of transfer-source storage (TB3) (S107), and online data transfer is started by the connected online data transfer software (S108).

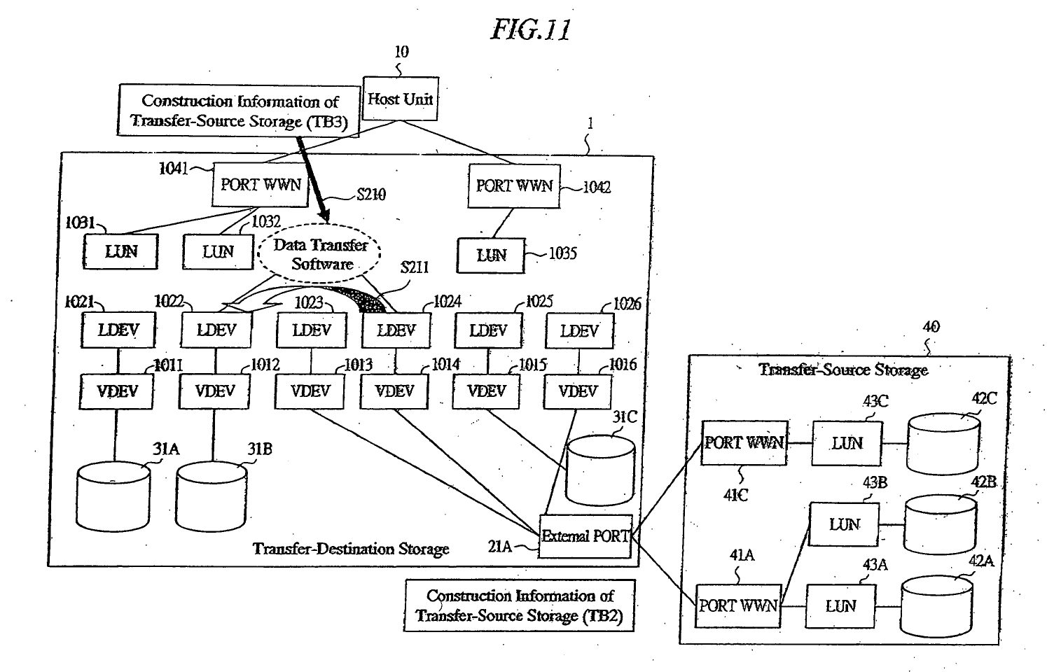

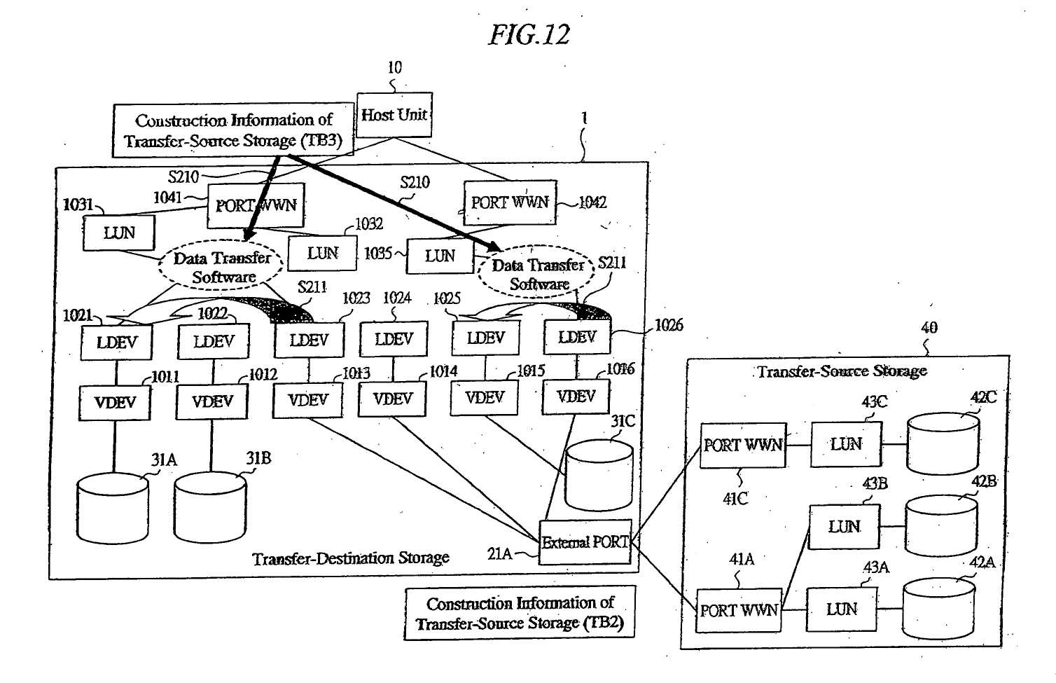

In the state of S107 shown in FIG. 3, as shown in FIG. 11, the connection of the online data transfer software is set to a LDEV 1024 to which the data transfer source is externally connected, and the data transfer destination serves as a LDEV 1022 created in the transfer-destination storage 1, on the basis of the construction information of transfer-source storage (TB3) created on the side of the host unit 10 (S210). Further, as shown in FIG. 12, the connection of the online data transfer software is set to a LDEV 1023 and a LDEV 1026 to which the data transfer source is externally connected and, the data transfer destination serves as a LDEV 1021 and a LDEV 1025 that are made in the transfer-destination storage 1 on the basis of the construction information of transfer-source storage (TB3) made on the side of the host unit 10 (S210).

By this setting, data transfer is performed from the LDEV 1024 to LDEV 1022, from the LDEV 1023 to LDEV 1021, and from the LDEV 1026 to LDEV 1025, by the online data transfer software (S211).

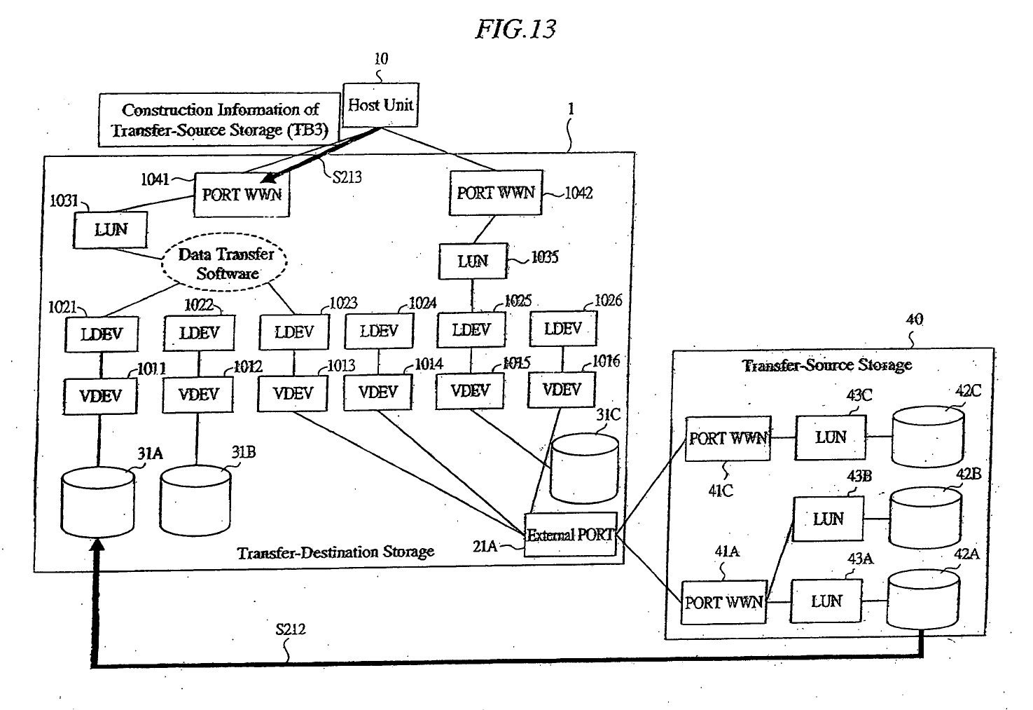

Further, in the state of S108 shown in FIG. 3, as shown in FIG. 13, data transfer is performed from the transfer-source storage 40 to the transfer-destination storage 1 (S212), and the data access from the host unit 10 is resumed (S213).

At this time, the data transfer software controls an appropriate access to the transfer-source LU or the transfer-destination LU with respect to an access request from the outside. For example, as for the data transfer, data is sequentially copied by the use of a copy pointer from a TOP of the LU, and as for online I/O, the untransferred data is read from or written to the transfer source and the read/write of the transferred data is issued to the transfer destination.

Then, when the online data transfer processing at S108 in FIG. 3 is finished, the transfer-source storage 40 is separated and the I/O from the host unit 10 is all shifted to the transfer-destination storage 1 to finish the data transfer processing (S109).

Note that, when necessary from the frequency of usage of data, inverse data transfer is performed to the transfer-source storage 40 without separating the transfer-source storage 40, whereby the data can be moved from the transfer-destination storage 1 to the transfer-source storage 40.

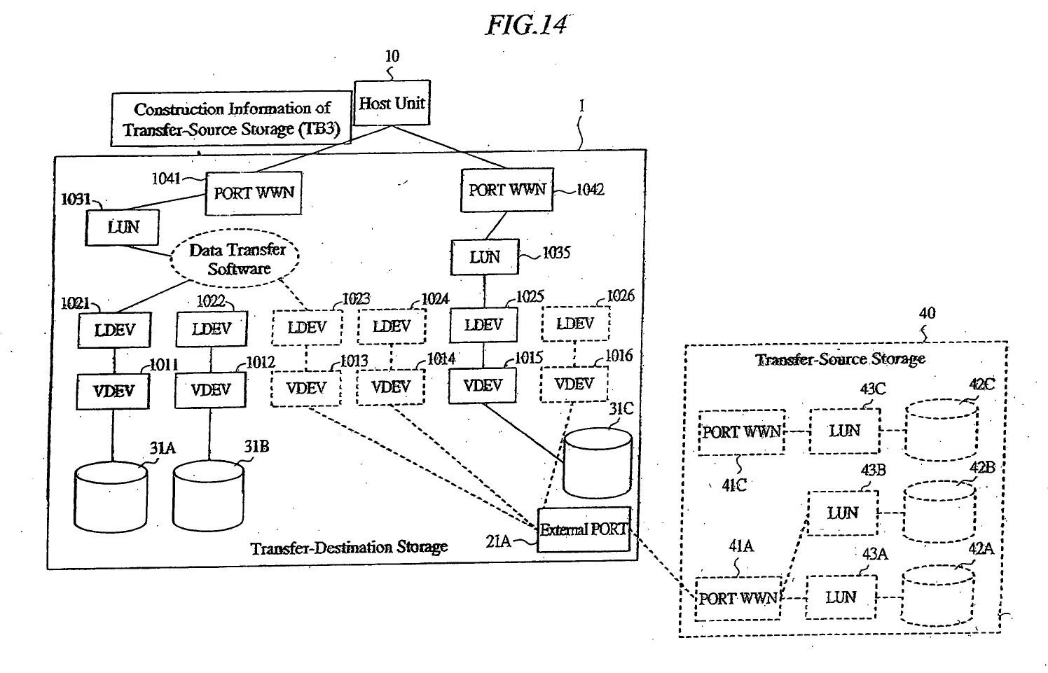

In the state of S109 shown in FIG. 3, as shown in FIG. 14, the transfer-source storage 40 is separated and only the transfer-destination storage 1 becomes used.

<Comparison Between Manual Mapping and Automatic Mapping>

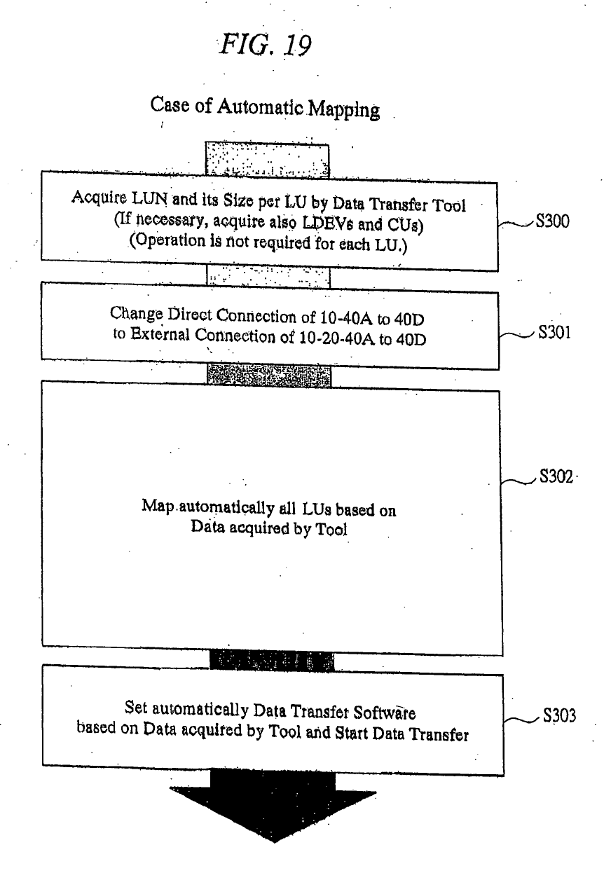

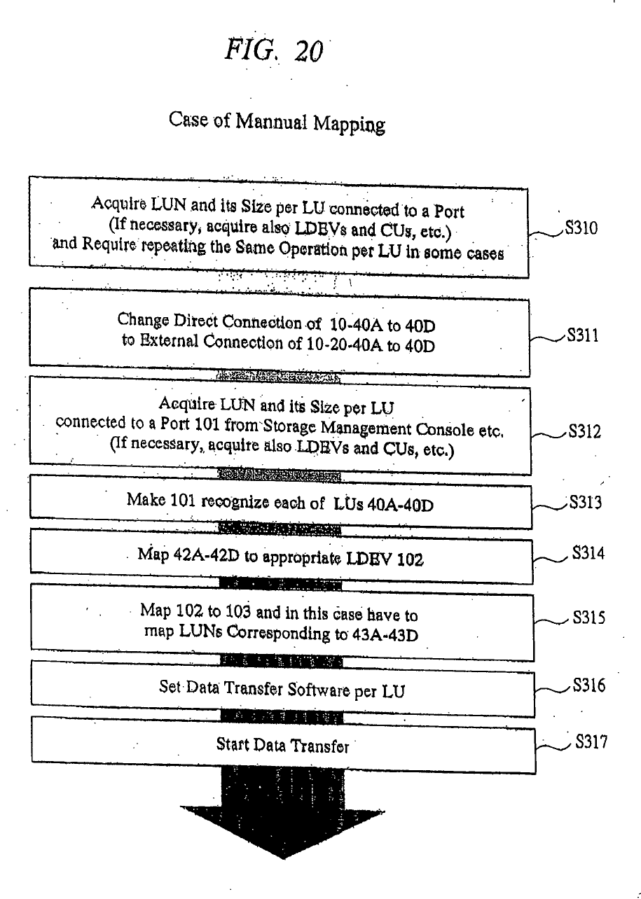

Next, an operation of performing an automatic mapping processing of the storage apparatus according to the first embodiment of the invention will be described by the use of FIGS. 2, 19 and 20. FIG. 19 is a flow chart showing an operation of performing an automatic mapping processing of the storage apparatus according to the first embodiment of the present invention. FIG. 20 is a flow chart showing an operation of performing a manual mapping processing to be a comparative example of the storage apparatus according to the first embodiment of the present invention.

First, in the case of performing the automatic mapping processing of this embodiment, as shown in FIG. 19, an LUN and size of each LU are acquired by the data transfer tool in the state where the host unit 10 shown in FIG. 2 is directly connected to the second storage apparatuses 40A to 40D (S300). At this time, if necessary, LDEVs and CUs are also acquired. In this case, an operation is not required for each LU.

Then, the direct connection between the host unit 10 and the second storage apparatuses 40A to 40D is changed to the external connection of the second storage apparatuses 40A to 40D to the first storage apparatus 1 (S301).

Then, after the changing of the direct connection to the external connection at S301, all the LUs are automatically mapped on the basis of data acquired by the data transfer tool (S302) and the data transfer software is automatically set on the basis of the data acquired by the data transfer tool and data transfer is started (S303).

In this manner, the mapping processing is automatically performed on the basis of the data acquired by the data transfer tool, and even if many mapping processings are required, they can be easily performed.

Further, in the case of performing the mapping processing manually as an example, as shown in FIG. 20, when the host unit 10 shown in FIG. 2 becomes directly connected to the second storage apparatuses 40A to 40D, the LUN and size of each LU connected to a certain port is acquired (S310). At this time, a LDEV and a CU are also acquired, if necessary. In this case, the same operation needs to be repeated for each LU in some cases.

Then, the direct connection between the host unit 10 and the second storage apparatuses 40A to 40D is changed to the external connection of the second storage apparatuses 40A to 40D to the first storage apparatus 1 (S311).

Then, after changing the direct connection to the external connection at S311, the LUN and size of each LU connected to a certain port are acquired from a storage management console or the like (S312) and the VDEV 101 is made to recognize the respective LUs 42A to 42D (S313).

Then, the LUs 42A to 42D are mapped to an appropriate LDEV 102 (S314) and the LDEV 102 is mapped to the LUN 103 (S315). At this time, LUNs corresponding to the LUNs 43A to 43D need to be mapped.

Then, the data transfer software is set for the respective LUs (S316) and the data transfer is started (S317).

In this manner, in the comparative example in which the mapping processing is manually performed, it is necessary to recognize the LU and map the LDEV 102 and LUN 103 for each LU. Therefore, when many mapping processings are required, the number of steps of work is increased and the accuracy of the work is reduced.

<Relation Between Mapping Table and Construction Information of Storage>

Next, a relation between a mapping table and storage construction information of the storage apparatus according to the first embodiment of the invention will be described with reference to FIG. 2.

In this embodiment, the mapping table Tm is a table for mapping an external volume to a VDEV. The storage construction information, reflected from the transfer source to the transfer destination at a time of the data transfer, includes at least information of “which CU and LDEV a certain LU is allotted to; which LUN a LU is allotted to; and what size a region for storing a LU has”. Note that, in the case of an open system, the CU and LDEV may not be reflected in any cases. Further, if possible, the WWN is also reflected and then data transfer thereof is performed.

Hence, the construction information of storage is, for example, information for recognizing the storage device 42A from the second storage apparatus 40A and is set as information for identifying the VDEV 101 (storage device 31 provided next thereto) from the host unit 10 at the time of the data transfer. The mapping table is information for identifying respective members from the LDEV 102 to the second storage apparatus 40A.

As described above, in this embodiment, the storage construction information of the transfer-source storage 40 is acquired by the data transfer tool, and the mapping at the time of performing the data transfer of the transfer-source storage 40 that is externally connected to the transfer-destination storage 1 is automatically performed. Hence, the online data transfer from the storage unit of the externally connected data-transfer source can be automatically performed. For this reason, since the environment of the transfer destination can be automatically set in view of the physical environment of LU, it is possible to eliminate determination of an allotting-destination port of LU. Therefore, it is possible to eliminate checking of the transfer-source environment and setting of the transfer-destination environment.

Note that, in this embodiment, all the volumes can be designated based on the WWN and LUN by the host unit 10. Hence, in the case of referring to data transferred from the transfer-destination storage 1, the same LUN is already prepared by the use of the above method. That is, for example, the “CU” and “LDEV” of the transfer-destination information in the construction information of transfer-source storage (TB1) are made by copying the transfer-source information. However, the WWN needs to be changed and hence data different from the WWN of the transfer-source storage 40 is set.

However, if a function of identifying itself as a WWN of transfer source (spoofing WWN) for the port of a transfer destination is mounted, it is also possible to eliminate the need for changing the WWN as described above.

### Second Embodiment

A second embodiment is such that the data transfer tool is operated not by the in-band host unit 10 but by an out-band host unit and the like in the first embodiment.

<Hardware Construction of Storage Apparatus>

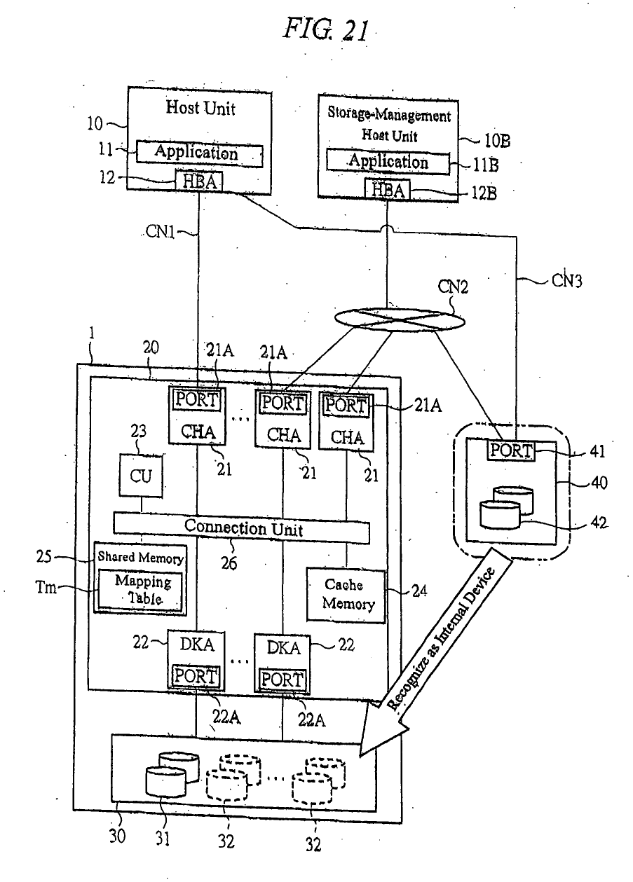

A construction of a storage apparatus according to the second embodiment of the present invention will be described with reference to FIG. 21. FIG. 21 is a block diagram showing a construction of a storage apparatus according to the second embodiment of the present invention and shows an out-band example by the host unit.

In FIG. 21, a storage management host unit 10B is connected to a communication network CN2 and manages the storage of the second storage apparatus 40. The storage management host unit 10B has applications 11B such as storage management software and a data transfer tool and acquires transfer-source information etc. from the second storage apparatus 40. The other constructions and operations of the respective parts are the same as those of the first embodiment shown in FIG. 1. Note that the storage management host unit 10B may be not connected through the communication network CN2 to the second storage apparatus 40 but be directly connected to the second storage apparatus 40.

In this embodiment, the second storage apparatus 40 is first connected to the host unit 10, and storage management of the second storage apparatus 40 is conducted and utilized by the storage management-host unit 10B. When the data transfer from the second storage apparatus 40 to the first storage apparatus 1 is conducted, the second storage apparatus 40 is externally connected to the first storage apparatus 1 and the second storage apparatus 40 is recognized as an internal storage device of the first storage control unit 20 to perform the data transfer during the online.

<Operation of Data Transfer Tool>

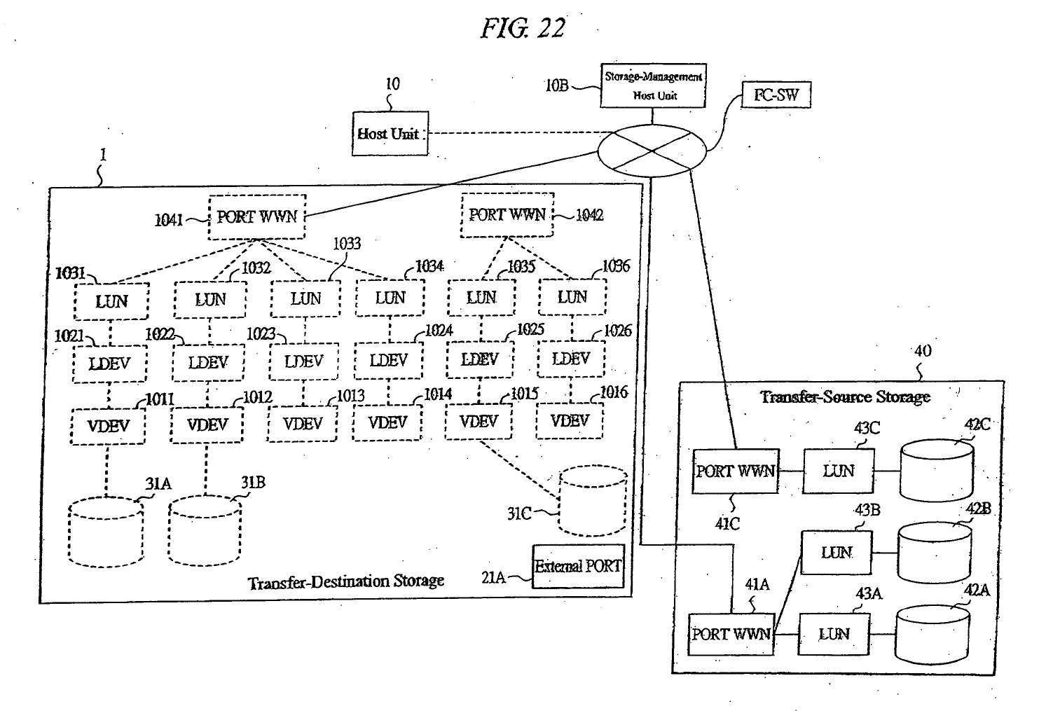

Next, an operation of the data transfer tool of the storage apparatus according to the second embodiment of the present invention will be described with reference to FIG. 22. FIG. 22 is a schematic diagram for describing a state where the data transfer tool of the storage apparatus according to the second embodiment of the present invention is being operated, and shows one logic schematic structure of the first storage apparatus 1 and the second storage apparatus 40.

In FIG. 22, the constructions of the transfer-source storage 40 and the transfer-destination storage 1, except that the storage management host unit 10B is connected to the communication network CN2, is the same as that in the first embodiment shown in FIGS. 4 to 14.

Further, the storage configuration information of the transfer-source storage 40 is acquired by the data transfer tool of the storage management host unit 10B, and operations other than those for performing the formatting of a LDEV, the setting of a transfer destination, the mapping of external connection, and the mapping of the LDEV to the LUN by the data transfer tool of the storage management host unit 10B are the same as those of the data transfer in the first embodiment shown in FIG. 3.

In this embodiment, not the host unit 10 but the storage management host unit 10B acquires the storage construction information of the transfer-source storage 40 and performs the mapping processing. Hence, the data transfer processing can be performed without stopping an in-band I/O from the host unit 10.

### Third Embodiment

A third Embodiment is such that the data transfer tool in the first embodiment is operated not by the in-band host unit 10 but by an out-band storage management console (SVP/Web console) etc. connected to the first storage apparatus 1 of the transfer destination, and the second storage unit 40 of the transfer source.

<Hardware Construction of Storage Apparatus>

A hardware construction of the storage apparatus in this embodiment is the same as that in the first embodiment shown in FIG. 1, and a storage management console (SVP/Web console) has a data transfer tool.

In this embodiment, the second storage apparatus 40 is first connected to the host unit 10. By storage management consoles 13, 14 that are connected respectively to the first storage apparatus 1 and the second storage apparatus 40, their storage management is conducted and utilized. When the data transfer from the second storage apparatus 40 to the first storage apparatus 1 is performed, the second storage apparatus 40 is externally connected to the first storage apparatus 1 and the second storage apparatus 40 is recognized as an internal storage device of the first storage control unit 20, whereby the data transfer during the online is performed.

<Operation of Data Transfer Tool>

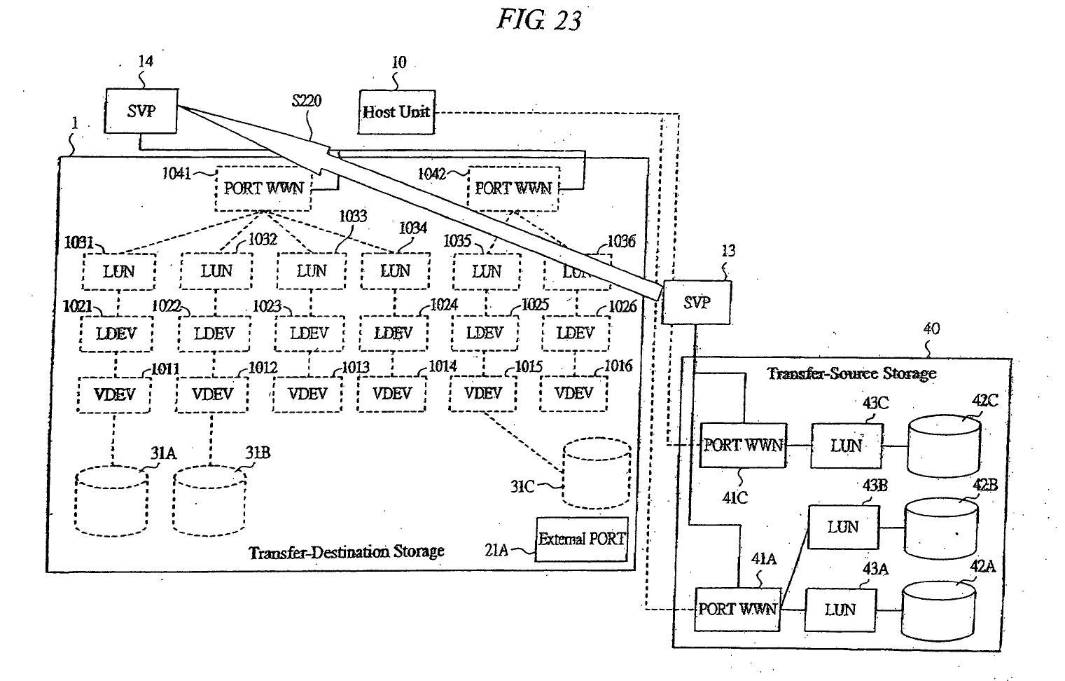

Next, an operation of a data transfer tool of the storage apparatus according to the third embodiment of the present invention will be described with reference to FIG. 23. FIG. 23 is a schematic diagram for describing a state where the data transfer tool of the storage apparatus according to the third embodiment of the present invention is being operated, and shows one logic schematic structure of the first storage apparatus 1 and the second storage apparatus 40.

In FIG. 23, the constructions of the transfer-source storage 40 and the transfer-destination storage 1, except that the storage management console 13 is connected to the transfer-source storage 40 and that the storage management console 14 is connected to the transfer-destination storage 1, is the same as that in the first embodiment shown in FIGS. 4 to 14.

Further, the storage construction information of the transfer-source storage 40 is acquired by the data transfer tool of the storage management console 13 connected to the transfer-source storage 40, and its storage management information is transferred to the storage management console 14 connected to the transfer-destination storage 1 by the use of a portable disk, a communication line or the like (S220). The operations except for those of performing the formatting of a LDEV, the setting of a transfer destination, the mapping of external connection, and the mapping of a LDEV to a LUN by the data transfer tool of the storage management console 14 are the same as those of the data transfer in the first embodiment shown in FIG. 3.

In this embodiment, not the host unit 10 but the storage management consoles 13, 14 connected to the transfer-source storage 40 and the transfer-destination storage 1 acquire the storage construction information of the transfer-source storage 40 and perform the mapping processing. Hence, a data transfer processing can be performed without requiring stopping the in-band I/O from the host unit 10.

### Fourth Embodiment

A fourth Embodiment is such that a data transfer tool in the first embodiment is operated not by the in-band host unit 10 but by the communication port 21A for external connection in the first storage apparatus 1 of the transfer destination.

<Hardware Construction of Storage Apparatus>

A hardware construction of a storage apparatus in this embodiment is the same as that in the first embodiment shown in FIG. 1 and the communication port 21A for external connection has a data transfer tool. Note that even if the communication port 21A for external connection does not have the data transfer tool, the communication port 21A for external connection may be controlled so as to operate the data transfer tool in the transfer-destination storage 1.

In this embodiment, the second storage apparatus 40 is first connected to the host unit 10 for utilization and when the data transfer from the second storage apparatus 40 to the first storage apparatus 1 is conducted, the second storage apparatus 40 is externally connected to the first storage apparatus 1 and the second storage apparatus 40 is recognized as an internal storage device of the first storage control unit 20, whereby the data transfer is performed during the online.

<Operation of Data Transfer Tool>

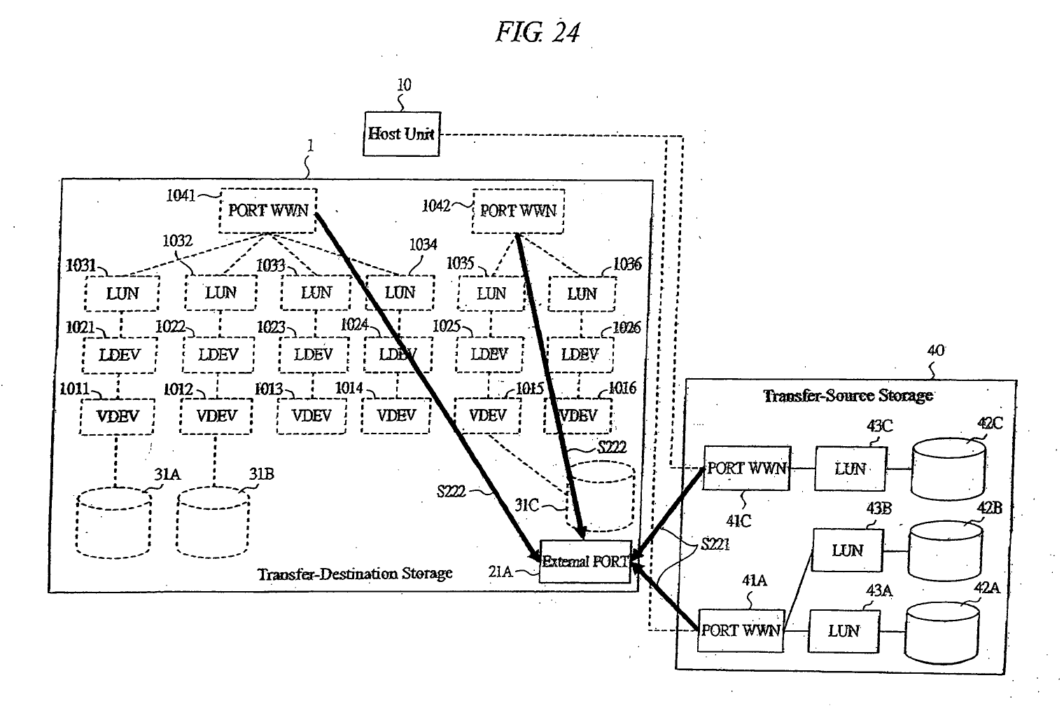

Next, an operation of the data transfer tool of the storage apparatus according to the fourth embodiment of the present invention will be described with reference to FIG. 24. FIG. 24 is a schematic diagram for describing a state where the data transfer tool of the storage apparatus according to the fourth embodiment of the present invention is being operated, and shows one logic schematic structure of the first storage apparatus 1 and the second storage apparatus 40.

In FIG. 24, the constructions of the transfer-source storage 40 and the transfer-destination storage 1, except that the communication port 21A for external connection in the transfer-destination storage 1 performs the operation of the data transfer tool, are the same as that in the first embodiment shown in FIGS. 4 to 14.

Further, the storage construction information of the transfer-source storage 40 is acquired by the data transfer tool of the communication port 21A for external connection in the transfer-destination storage 1 (S221), and the storage construction information of the transfer-destination storage 1 is also acquired by the data transfer tool of the communication port 21A for external connection (S222). The operations except for those of performing the formatting of a LDEV, the setting of a transfer destination, the mapping of external connection, and the mapping of a LDEV to a LUN by the data transfer tool of the communication port 21A for external connection, are the same as those of the data transfer in the first embodiment shown in FIG. 3.

In this embodiment, not the host unit 10 but the communication port 21A for external connection in the transfer-destination storage 1 acquires the storage construction information of the transfer-source storage 40 and performs the mapping processing. Hence, the data transfer processing can be performed without stopping the in-band I/O from the host unit 10. Further, the mapping can be automatically performed only by connecting the transfer-source storage 40 externally to the transfer-destination storage 1, whereby the number of steps of performing the data transfer processing during the online can be reduced.

As described above, the embodiments of the invention made by the present inventors have been concretely explained. However, the present invention is not limited to the above-mentioned embodiments and, needless to say, can be variously altered and modified without departing from the gist thereof.

Effects of representative ones of inventions disclosed in the present application will be briefly described as follows.

According to the invention, the mapping can be automatically performed when the online data transfer is performed from the externally connected transfer-source storage. Hence, the environment of the transfer destination can be automatically set in view of the physical environment of the LU, so that it is possible to eliminate the determining of the allotting-destination port of LU, the recognizing of the environment of the transfer source, and the setting of the environment of the transfer destination.

What is claimed is:

1. A storage apparatus comprising:
a storage control unit; and
a storage unit,
wherein said storage control unit includes:
a plurality of channel adaptors establishing communication with a host unit;
a plurality of disk adaptors establishing communication with said storage unit;
a cache memory temporarily storing data transferred between said host unit and said storage unit;
a shared memory storing control information that communicates with said channel adaptors and said disk adaptors;
a connection unit to which said channel adaptors, said disk adaptors, said cache memory, and said shared memory are connected;
an external connection port to which an external storage unit is connected;
an external connection function recognizing, as an internal storage device, a storage device in said external storage unit connected via said external connection port; and
an online data transfer function performing data transfer between said internal storage devices while processing an access from the host unit,
wherein said storage unit includes a plurality of storage devices, and
wherein the storage apparatus further comprises a data transfer means for: acquiring construction information of said external storage unit before said external storage unit is connected to said external connection port; making a storage device for performing data transfer from said external storage unit, with respect to said storage control unit in accordance with the acquired construction information of said external storage unit; and performing mapping of the storage device in said external storage unit and data transfer from said external storage unit to a side of said storage control unit, with respect to said external connection function and said online data transfer function, after said external storage unit is connected to said external connection port.

2. The storage apparatus according to claim 1,
wherein said external connection port uses a port of a portion in said channel adaptors.

3. The storage apparatus according to claim 1,
wherein said data transfer means acquires the construction information from said external storage unit by using a SCSI command or a command device.

4. The storage apparatus according to claim 1,
wherein the construction information of said external storage unit is managed as transfer-source-storage construction information, said transfer-source-storage construction information including transfer-source information, transfer-destination information obtained from the transfer-source information, and external-connection-destination information by said external connection function.

5. The storage apparatus according to claim 1,
wherein said data transfer means is processed in said host unit.

6. The storage apparatus according to claim 5,
wherein said host unit is connected to: a storage unit connected to said external connection port before said external storage unit is connected to said external connection port; and said storage control unit after the construction information of said external storage unit is acquired.

7. The storage apparatus according to claim 1,
wherein said data transfer means is processed in a host unit for storage management different from said host unit.

8. The storage apparatus according to claim 1,
wherein said data transfer means is processed in: a first storage management console connected to said external storage unit before said external storage unit is connected to said external connection port; and a second storage management console connected to said storage control unit having acquired the construction information of said external storage unit from the first storage management console after said external storage unit is connected to said external connection port.

9. The storage apparatus according to claim 1,
wherein said data transfer means is processed in the external connection port of said storage control unit.

10. The storage apparatus according to claim 9,
wherein said data transfer means in said external connection port acquires the construction information of said external storage unit after said external storage unit is connected to said external connection port.

11. A data transfer method of a storage apparatus comprising a storage control unit and a storage unit,
said storage control unit including:
a plurality of channel adaptors establishing communication with a host unit;
a plurality of disk adaptors establishing communication with said storage unit;
a cache memory temporarily storing data transferred between said host unit and said storage unit;
a shared memory storing control information that communicates with said channel adaptors and said disk adaptors;
a connection unit to which said channel adaptors, said disk adaptors, said cache memory, and said shared memory are connected;
an external connection port to which an external storage unit is connected;
an external connection function recognizing, as an internal storage device, a storage device in said external storage unit connected via said external connection port; and
an online data transfer function performing data transfer between said internal storage devices while processing an access from the host unit, and
said storage unit including a plurality of storage devices,
wherein a data transfer process from said external storage unit to a side of said storage control unit comprising the steps of:
acquiring construction information of said external storage unit before said external storage unit is connected to said external connection port;
making a storage device for performing data transfer from said external storage unit with respect to said storage control unit in accordance with the acquired construction information of said external storage unit; and
performing mapping of the storage device in said external storage unit and data transfer from said external storage unit to a side of said storage control unit, with respect to said external connection function and said online data transfer function, after said external storage unit is connected to said external connection port.

12. The data transfer method of a storage apparatus according to claim 11,
wherein said external connection port uses a port of a portion in said channel adaptors.

13. The data transfer method of a storage apparatus according to claim 11,
wherein the construction information from said external storage unit is acquired by a SCSI command or a command device.

14. The data transfer method of a storage apparatus according to claim 11,
wherein the construction information of said external storage unit is managed as transfer-source-storage construction information, said transfer-source-storage construction information including transfer-source information, transfer-destination information obtained from the transfer-source information, and external-connection-destination information by said external connection function.

15. The data transfer method of a storage apparatus according to claim 11,
wherein said data transfer means is processed in said host unit.

16. The data transfer method of a storage apparatus according to claim 15,
wherein said host unit is connected to: a storage unit connected to said external connection port before said external storage unit is connected to said external connection port; and said storage control unit after the construction information of said external storage unit is acquired.

17. The data transfer method of a storage apparatus according to claim 11,
wherein said data transfer means is processed in a host unit for storage management different from said host unit.

18. The data transfer method of a storage apparatus according to claim 11,
wherein said data transfer means is processed in: a first storage management console connected to said external storage unit before said external storage unit is connected to said external connection port; and a second storage management console connected to said storage control unit having acquired the construction information of said external storage unit from the first storage management console after said external storage unit is connected to said external connection port.

19. The data transfer method of a storage apparatus according to claim 11,
wherein said data transfer means is processed in the external connection port of said storage control unit.

20. The data transfer method of a storage apparatus according to claim 19,
wherein said data transfer process in said external connection port includes acquiring the construction information of said external storage unit after said external storage unit is connected to said external connection port.
